(19) United States
(12) Patent Application Publication
(10) Pub. No.: US 2009/0142010 A1
(43) Pub. Date: Jun. 4, 2009

(54) SINTERED METAL MATERIAL, SINTERED OIL-IMPREGNATED BEARING FORMED OF THE METAL MATERIAL, AND FLUID LUBRICATION BEARING DEVICE

(75) Inventors: Fuyuki Ito, Kuwana-shi (JP); Kazuo Okamura, Kuwana-shi (JP); Toshihiko Tanaka, Aichi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi, Osaka (JP)

(21) Appl. No.: 11/719,809

(22) PCT Filed: Dec. 27, 2005
(86) PCT No.: PCT/JP2005/023897

§ 371 Date: Jan. 16, 2009

(30) Foreign Application Priority Data
Jan. 5, 2005 (JP) 2005-000969
Jan. 6, 2005 (JP) 2005-001781
Dec. 21, 2005 (JP) 2005-368338

(51) Int. Cl. F16C 33/10; C22C 9/00

(52) U.S. Cl. 384/279; 420/496; 508/108; 508/105

(57) ABSTRACT

Provided are a sintered metal material improved in sliding property and wear resistance with respect to an associated sliding member to be supported, and a sintered oil-impregnated bearing formed of this metal material. A bearing sleeve is formed by compacting a mixed metal powder composed of not less than 5 wt % and not more than 94.3 wt % of Cu powder, not less than 5 wt % and not more than 94.3 wt % of SUS powder, not less than 0.2 wt % and not more than 10 wt % of Sn powder, and not less than 0.5 wt % and not more than wt % of graphite, and then performing sintering on a compact of the mixed metal powder.

### BACKGROUND OF THE INVENTION

1. Field of the Invention

The present invention relates to a sintered metal material, a sintered oil-impregnated bearing formed of this metal material, and a fluid lubrication bearing device.

2. Description of the Related Art

A sintered metal material is used in many fields including the field of a sintered oil-impregnated bearing as mentioned above. Above all, in a sintered oil-impregnated bearing, as relative rotation is performed between itself and the shaft to be supported, a lubricating fluid with which it is impregnated oozes out to a sliding portion between the bearing and the shaft to form a lubricant film, and through the intermediation of this oil film, the shaft is rotatably supported. Such a sintered oil-impregnated bearing is suitably used in a portion where a particularly high bearing performance and durability are required, for example, in an automotive bearing component or a motor spindle for an information apparatus.

Regarding a motor for an information apparatus as mentioned above, use is being considered, or already actually practiced, of a fluid lubrication bearing, which exhibits high rotational precision, high speed rotation property, and low noise property, and low cost.

Fluid lubrication bearings of this type are roughly classified into hydrodynamic pressure bearings equipped with a hydrodynamic pressure generating portion for generating hydrodynamic pressure in a fluid (e.g., a lubricating oil) in a bearing gap, and so-called cylindrical bearings (bearings whose sectional configuration is perfectly circular) equipped with no such hydrodynamic pressure generating portion.

For example, in a fluid lubrication bearing device incorporated in a spindle motor for a disk drive device, such as an HDD, both the radial bearing portion supporting the shaft member in the radial direction and the thrust bearing portion supporting the shaft member in the thrust direction are formed by hydrodynamic pressure bearings. In a known radial bearing portion in a hydrodynamic pressure bearing device of this type, hydrodynamic pressure grooves as a hydrodynamic pressure generating portion are formed, for example, either in the inner peripheral surface of a bearing sleeve or in the outer peripheral surface of a shaft member opposed thereto, and a radial bearing gap is formed between the two surfaces (see, for example, JP 2003-239951 A).

In many cases, a sintered oil-impregnated bearing is used as a bearing sleeve constituting the above-mentioned bearing in order to circulate and supply lubricating oil for the bearing portion and to attain a stable bearing stiffness. Such a bearing sleeve (a sintered oil-impregnated bearing) is formed by compacting a metal powder whose main component is Cu powder or Fe powder, or both of them into a predetermined configuration (in many cases, a cylindrical configuration), and then sintering the same. Such a bearing sleeve is used with its inner voids impregnated with a fluid, such as a lubricating oil or a lubricating grease (see, for example, JP 11-182551 A).

On the other hand, taking into account the case where the shaft which is rotatably supported is used under the action of an axial compressive load or the action of a moment load, it is formed of a material of high strength, such as stainless steel (SUS).

In a sintered oil-impregnated bearing of this type, sliding friction between itself and the shaft to be supported is unavoidable, so a satisfactory sliding property and high wear resistance are required of the sliding surface (bearing surface) on which the shaft slides.

However, while it is satisfactory as far as the sliding property (conformability) with respect to the shaft is concerned a sintered oil-impregnated bearing is not always satisfactory in terms of wear resistance. In particular, when the associated member is formed of a material of higher hardness (e.g., SUS), there is a fear of the sintered oil-impregnated bearing undergoing premature wear.

Further, taking into account the changes in bearing performance due to the use environment of the fluid lubrication bearing device, when, for example, it is used in a high temperature atmosphere, the viscosity of the lubricating oil supplied to the bearing may be reduced depending upon the temperature or the kind of lubricating oil used, resulting in a shortage of bearing stiffness. On the other hand, in a low temperature environment, the viscosity of the lubricating oil increases, and there is a fear of the loss torque during rotation (in particular, at the rotation start) increasing.

In particular, when, taking into account the use under the action of an axial compressive load and under the action of a moment load, the shaft member to be rotatably supported is formed of a high strength material such as SUS as stated above, it is not unusual that the coefficient of linear expansion of the material forming the bearing sleeve is larger than the coefficient of linear expansion of the material forming the shaft member. In this case, for example, at high temperature, the radial bearing gap becomes rather large, and there is a fear of a further reduction in bearing stiffness. On the other hand, at low temperature, the radial bearing gap becomes rather small, so with the increase in the viscosity of the lubricating oil, there is a fear of a further increase in loss torque during rotation.

### SUMMARY OF THE INVENTION

It is a first object of the present invention to provide a sintered metal material improved in sliding property and wear resistance with respect to the associated sliding member to be supported, and a sintered oil-impregnated bearing formed of this metal material.

A second object of the present invention is to provide a fluid lubrication bearing device in which a reduction in bearing stiffness due to temperature changes is suppressed and in which a reduction in loss torque during rotation is achieved.

To achieve the first object mentioned above, the present invention provides a sintered metal material obtained by compacting a mixed metal powder containing Cu powder and SUS powder and then sintering a compact of the mixed metal powder. Here, the term Cu powder covers, pure Cu powder, a Cu alloy powder mixed with some other metal, and a Cu-coated metal powder in which Cu coating layers are formed on the surfaces of the particles of some other metal.

Further, to achieve the first object, the present invention provides a sintered oil-impregnated bearing formed of a sintered metal material composed of a mixed metal powder as mentioned above and having, in its inner periphery, a bearing surface supporting the sliding surface of a shaft to be supported through the intermediation of a lubricant film.

By thus mixing SUS powder into the material, the hardness of the formed surface of the sintered metal material (the bearing surface of the sintered oil-impregnated bearing) is enhanced. On the other hand, by mixing Cu powder into the material, it is possible to secure a satisfactory sliding property (conformability) for the formed surface (bearing surface) with respect to the associated sliding member (shaft). Thus, a sintered metal material is formed of a mixed metal powder containing those two powders, or a sintered oil-impregnated bearing is formed of this sintered metal material, whereby it is possible to achieve an improvement in wear resistance with respect to the associated sliding member, and it is possible to obtain a satisfactory sliding property with respect to the associated sliding member (low friction and low loss torque).

Various types of SUS powders can be used. Above all, for example, SUS powder containing not less than 5 wt % and not more than 16 wt % of Cr may be preferably used, and more preferably, SUS powder containing not less than 6 wt % and not more than 10 wt % of Cr may be used. This is due to the fact that when the Cr content existing in the SUS powder in an alloyed state exceeds 16 wt %, there is a fear of the secondary formability of the sintered material (formability after sintering) or the strength of the sintered material being adversely affected. On the other hand, when the Cr content is less than 5 wt %, the hardness of the SUS powder mixed therewith is insufficient, so an improvement in terms of wear resistance may not be achieved.

As the mixed metal powder containing Cu powder and SUS powder, it is desirable to adopt one containing 5 wt % to 95 wt % of Cu powder and 5 wt % to 95 wt % of SUS powder. When the SUS powder content is less than 5 wt %, there is a fear of the improvement in wear resistance due to the mixing of the SUS powder being insufficient. When the content of Cu powder is less than 5 wt %, a satisfactory sliding property (conformability with respect to the associated sliding member) may not be secured.

The mixed metal powder containing Cu powder and SUS powder may be further mixed, for example, with a powder of a low melting point metal (a metal melting at a temperature not higher than the sintering temperature; inclusive of an alloy). This measure is taken in view of the fact that, by mixing a metal powder that can be melted at the sintering temperature, which is usually set lower than the melting point of Cu powder or SUS powder, the molten (liquid) metal acts as a binder between the particles of the Cu powder or between the particles of the Cu and SUS powders. As a result, it is possible to enhance the mechanical strength of the sintered metal material after sintering or that of the sintered oil-impregnated bearing.

The low melting point metal is a metal melting at a temperature not higher than a predetermined sintering temperature (the sintering temperature of the sintered oil-impregnated bearing is usually 750 to 1000° C.). It is possible to use, for example, a metal, such as Sn, Zn, Al, or P, or an alloy containing two or more of these metals. Above all, Sn is particularly preferable since it is alloyed with Cu in the liquid phase to enhance the hardness of the molding surface of the sintered metal material (the bearing surface of the sintered oil-impregnated bearing).

When further mixing a low melting point metal powder into the material metal powder containing Cu powder and SUS powder, the mixing proportion is preferably as follows: Cu powder: not less than 5 wt % and not more than 94.8 wt %; SUS powder: not less than 5 wt % and not more than 94.8 wt %; and the low melting point metal powder: not less than 0.2 wt % and not more than 10 wt %.

To further enhance the sliding property of the sliding surface, it is also possible to further mix a slid lubricant, such as graphite, into the above mixed metal powder. However, graphite is very poor in binding property at the time of sintering with respect to the metal powder such as Cu, so when graphite is mixed, there is a fear of the strength of the sintered body being reduced. Thus, care must be taken regarding the mixing amount of the graphite.

From the above viewpoint, the upper limit value of the graphite mixing amount is 2.5 wt %. By keeping the graphite mixing amount within this range, it is possible to minimize the reduction in strength of the sintered metal material and that of the sintered oil-impregnated bearing obtained by sintering the materials. On the other hand, taking into account the fact that the mixing of SUS powder, which is relatively hard as compared with other metals, leads to enhancement in aggressiveness with respect to the mold at the time of molding, it is desirable for the lower limit value of the graphite mixing amount to be not less than 0.5 wt %. This helps to achieve an improvement in sliding property at the time of molding with respect to the mold, making it possible to mitigate the damage involved when the mold is continuously used.

In this case, the mixing proportion of the whole is preferably as follows: Cu powder: not less than 5 wt % and not more than 94.5 wt %; SUS powder: not less than 5 wt % and not more than 94.5 wt %; and graphite: not less than 0.5 wt % and not more than 2.5 wt %. When a low melting point metal powder is further mixed, the mixing proportion of the whole is preferably as follows: Cu powder: not less than 5 wt % and not more than 94.3 wt %; SUS powder: not less than 5 wt % and not more than 94.3 wt %; graphite: not less than 0.5 wt % and not more than 2.5 wt %; and low melting point metal powder: not less than 0.2 wt % and not more than 10 wt %.

In the sintered oil-impregnated bearing formed of the sintering metal material of the above composition, it is possible to form a hydrodynamic pressure generating portion in the bearing surface provided in the inner periphery thereof. In this case, the sintered oil-impregnated bearing supports the shaft rotatably in a non-contact fashion by the hydrodynamic pressure action of the fluid generated in the gap between the bearing and the shaft to be supported.

The above-mentioned sintered oil-impregnated bearing may be provided, for example, as a fluid lubrication bearing device having a sintered oil-impregnated bearing. Further, this fluid lubrication bearing device may be provided as a motor equipped with a fluid lubrication bearing device.

To achieve the second object mentioned above, the present invention provides a fluid lubrication bearing device including a shaft member and a bearing sleeve for rotatably supporting the shaft member, characterized in that the bearing sleeve is obtained by compacting a mixed metal powder containing Cu powder and a metal powder exhibiting a coefficient of linear expansion of 8.0×10⁻⁶/° C., and then performing sintering on a compact of the mixed metal powder.

By thus forming the bearing sleeve of a material obtained by mixing the Cu powder with a metal powder having a small coefficient of linear expansion (up to 8.0×10⁻⁶/° C.), the coefficient of linear expansion of the bearing sleeve becomes smaller than that of a bearing sleeve of the conventional composition (Cu and Fe). Thus, when the viscosity of the lubricating oil is reduced, for example, at high temperature, it is possible to suppress, as far as possible, the expansion of the radial bearing gap. When the viscosity of the lubricating oil increases, for example, at low temperature, it is possible to suppress, as far as possible, the reduction of the radial bearing gap. Thus, even in a high/low temperature atmosphere or in an atmosphere in which there is a marked change in temperature, it is possible to suppress, as far as possible, the reduction in bearing stiffness and to reduce the loss torque during rotation.

Examples of the metal exhibiting the above coefficient of linear expansion include unitary metals, such as Mo and W, and an Fe—Ni alloy containing not less than 25 wt % and not more than 50 wt % of Ni. Above all, an Fe—Ni alloy containing not less than 30 wt % and not more than 45 wt % of Ni may be used more preferably. Specific examples of the material include an Invar-type (Fe-36Ni) alloy powder, a Super-Invar-type (Fe-32Ni-4Co, Fe-31Ni-5Co) alloy powder, and a Kovar-type alloy powder. Those have a markedly small coefficient of linear expansion, and constitute particularly suitable materials that can be used.

As such mixed metal powder containing Cu powder and a low linear expansion metal powder, it is possible to suitably use one containing not less than 30 wt % and not more than 90 wt % of Cu powder and not less than 10 wt % and not more than 70 wt % of low linear expansion metal powder. This is due to the following facts. When the content of the low linear expansion metal powder is less than 10 wt %, there is a fear of the linear expansion coefficient reducing effect due to the mixing of the low linear expansion metal powder being rather insufficient. When the Cu powder content is less than 30 wt %, there is a fear of the formability (workability) of the bearing sleeve deteriorating, thereby making it impossible to secure the requisite dimensional accuracy or aggravating the wear of the mold.

Further, to achieve a reinforcing effect for the bearing sleeve, it is also possible to further mix SUS powder into the mixed metal powder containing Cu powder and Fi—Ni alloy powder. This helps not only to reinforce the bearing sleeve but also to improve the wear resistance of the bearing sleeve.

As the mixed metal powder containing SUS powder, it is desirable to use not less than 30 wt % and not more than 80 wt % of Cu powder, not less than 10 wt % and not more than 65 wt % of low linear expansion metal powder, and not less than 5 wt % and not more than 60 wt % of SUS powder. By mixing the powders in a proportion within the above range, it is possible to keep both the low linear expansion property and the wear resistance of the bearing sleeve at high level.

In this way, the bearing sleeve is formed of a mixed metal powder composed of Cu powder, Fe—Ni alloy powder as the low linear expansion metal powder, or of CU powder and Fe—Ni alloy powder, or of a mixed metal powder further containing SUS powder. It is also possible to mix a low melting point metal, such as Sn or Zn, into such mixed metal powder. This low melting point metal is melted (turned into the liquid phase) at the time of sintering to function as a binder for the Cu powder and the low linear expansion metal powder. Here, the low melting point metal refers to a metal which is melted at a temperature not higher than the temperature at which the low melting point metal is sintered (sintering temperature) after the mixed metal powder is compacted.

A bearing sleeve formed of a mixed metal powder of the above composition may have, in the inner peripheral surface thereof, a hydrodynamic pressure generating portion. In this case, a hydrodynamic pressure action of a fluid is generated in the radial bearing gap between the hydrodynamic pressure generating region constituting the radial bearing surface of the bearing sleeve and the outer peripheral surface of the shaft member to be supported, and the shaft member is supported rotatably in a non-contact fashion.

A fluid lubrication bearing device equipped with the above bearing sleeve may be provided, for example, as a disk device spindle motor in which this fluid lubrication bearing device is incorporated.

As described above, according to the present invention, it is possible to provide a sintered metal material improved in terms of wear resistance and sliding property with respect to the shaft to be supported, and a sintered oil-impregnated bearing formed of this metal material.

Further, according to the present invention, it is possible to provide a fluid lubrication bearing device in which a reduction in bearing stiffness due to temperature changes is suppressed and in which the loss torque during rotation is reduced.

### BRIEF DESCRIPTION OF THE DRAWINGS

FIG. 1 is a sectional view of an information apparatus spindle motor in which a fluid lubrication bearing device according to a first embodiment of the present invention is incorporated.

FIG. 2 is a sectional view of the fluid lubrication bearing device.

FIG. 3A is a longitudinal sectional view of the bearing sleeve.

FIG. 3B shows a lower end surface of the bearing sleeve.

FIG. 4 is a sectional view of an information apparatus spindle motor in which a fluid lubrication bearing device according to a second embodiment of the present invention is incorporated.

FIG. 5 is a sectional view of the fluid lubrication bearing device.

FIG. 6A is a longitudinal sectional view of the bearing sleeve.

FIG. 6B shows a lower end surface of the bearing sleeve.

FIG. 7 is a microphotograph of the interior of a bearing sleeve.

FIG. 8 is a sectional view of another construction example of the radial bearing portion.

FIG. 9 is a sectional view of another construction example of the radial bearing portion.

FIG. 10 is a sectional view of another construction example of the radial bearing portion.

FIG. 11 is a table showing composition of a test specimen material according to Example 1.

FIGS. 12A through 12E are tables each showing powder particle size distribution in Example 1.

FIG. 13 is a table showing wear test results in Example 1.

FIG. 14 is a table showing composition of a test specimen material according to Example 2.

FIGS. 15A through 15F are tables each showing powder particle size distribution in Example 2.

FIG. 16 is a table showing linear expansion coefficient measurement test results in Example 2.

FIG. 17 is a table showing wear test results in Example 2.

### DETAILED DESCRIPTION OF THE PREFERRED EMBODIMENTS

In the following, a first embodiment of the present invention will be described with reference to FIGS. 1 through 3.

FIG. 1 is a conceptual drawing showing a construction example of a fluid lubrication bearing device (hydrodynamic pressure bearing device) 1 equipped with a sintered oil-impregnated bearing according to an embodiment of the present invention and an information apparatus spindle motor in which the fluid lubrication bearing device 1 is incorporated. This spindle motor is used in a disk drive device, such as an HDD, and is equipped with the fluid lubrication bearing device 1 supporting a shaft member 2 rotatably in a non-contact fashion, a disk hub 3 attached to the shaft member 2, and a stator coil 4 and a rotor magnet 5 that are opposed to each other through the intermediation of a radial gap. The stator coil 4 is attached to the outer periphery of a bracket 6, and the rotor magnet 5 is attached to the inner periphery of the disk hub 3. The disk hub 3 retains in its outer periphery one or a plurality of (two in FIG. 1) disc-like information storage media, such as magnetic disks (hereinafter simply referred to as disks) D. In the spindle motor, constructed as described above, when the stator coil 4 is energized, the rotor magnet 5 is caused to rotate by an electromagnetic force generated between the stator coil 4 and the rotor magnet 5, and with this rotation, the disk hub 3 and the disks D retained by the disk hub 3 rotate integrally with the shaft member 2.

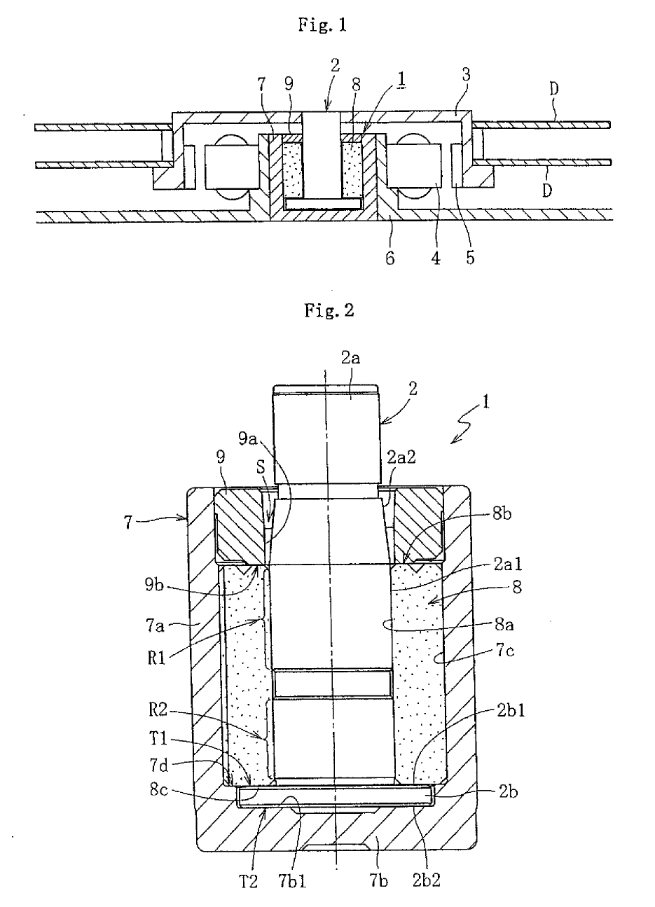

FIG. 2 shows the fluid lubrication bearing device 1. The fluid lubrication bearing device 1 is mainly composed of the shaft member 2, a housing 7, a bearing sleeve 8 fixed to the housing 7, and a seal member 9. For the sake of convenience in illustration, a bottom portion 7b side of the housing 7 will be referred to as the lower side and the side thereof opposite to the bottom portion 7b will be referred to as the upper side.

The shaft member 2 is formed of a metal material, such as stainless steel, and is equipped with a shaft portion 2a and a flange portion 2b provided integrally or separately at the lower end of the shaft portion 2a. The shaft member 2 may be of a hybrid structure formed of metal material and resin material. In this case, the sheath portion including at least an outer peripheral surface 2a1 of the shaft portion 2a is formed of the metal, and the remaining portions (e.g., the core portion of the shaft portion 2a and the flange portion 2b) are formed of resin.

The housing 7 is formed by injection molding of a resin composition whose base resin is LCP, PPS, PEEK or the like, and as shown, for example, in FIG. 2, is composed of a cylindrical portion 7a and a bottom portion 7b formed integrally at the lower end of the cylindrical portion 7a. According to the purpose, the resin composition forming the housing 7, allows mixing, in an appropriate amount, of, for example, a fibrous filler such as glass fiber, a whisker-like filler such as potassium titanate, a scaly filler such as mica, and a fibrous or a powdered conductive filler, such as carbon fiber, carbon black, graphite, carbon nanomaterial, or various kinds of metal powder.

For example, although not shown, there is formed, all over or in a partially annular region of an upper end surface 7b1 of the bottom portion 7b, a region where a plurality of hydrodynamic pressure grooves are arranged in a spiral fashion as a thrust hydrodynamic pressure generating portion. This hydrodynamic pressure generating region is opposed to a lower end surface 2b2 of the flange portion 2b, and during rotation of the shaft member 2, forms a thrust bearing gap of a second thrust bearing portion T2 (see FIG. 2) between itself and the lower end surface 2b2. These hydrodynamic pressure grooves can be formed simultaneously with the housing 7 by machining, at a predetermined position of the mold for molding the housing 7 (the position where the upper end surface 7b1 is to be formed), groove forms for forming the hydrodynamic pressure grooves. Further, at a position upwardly spaced apart in the axial direction from the upper end surface 7b1 by a predetermined dimension, there is integrally formed a step portion 7d to be engaged with a lower end surface 8c of the bearing sleeve 8 to effect positioning in the axial direction.

The bearing sleeve 8 is formed in a cylindrical configuration of a porous material composed of a sintered material whose main components are Cu (or a Cu alloy) and SUS, and is fixed to the inner peripheral surface 7c of the housing 7. As described below, the inner voids of the bearing sleeve 8 are filled with a lubricating oil to thereby form a sintered oil-impregnated bearing.

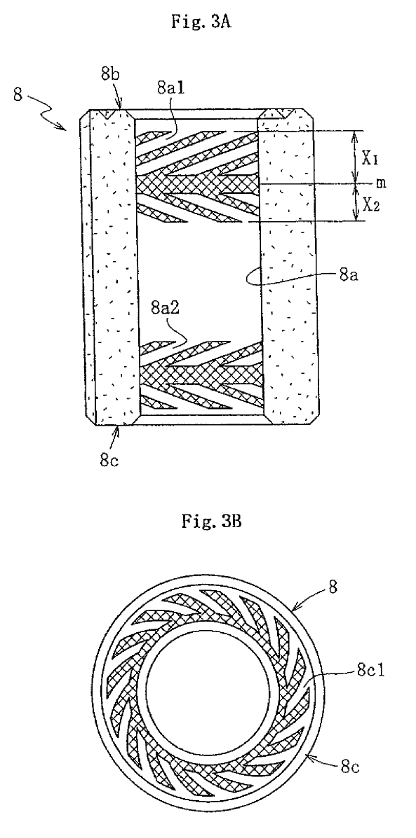

All over or in a partial cylindrical region of the inner peripheral surface 8a of the bearing sleeve 8, there are formed hydrodynamic pressure grooves as the radial hydrodynamic pressure generating portion. As shown, for example, in FIG. 3A, in this embodiment, there are formed two regions, axially spaced apart from each other, in which a plurality of hydrodynamic pressure grooves 8a1 and 8a2 are arranged in a herringbone-like fashion. In the upper region, where the hydrodynamic pressure grooves 8a1 are formed, the hydrodynamic pressure grooves 8a1 are formed in axial asymmetry with respect to an axial center m (the axial center of the region between the upper and lower oblique grooves), with an axial dimension X1 of the region on the upper side of the axial center m being larger than an axial dimension X2 of the region on the lower side of the axial center m.

As shown, for example, in FIG. 3B, all over or in a partial annular region of the lower end surface 8c of the bearing sleeve 8, there is formed a region where a plurality of hydrodynamic pressure grooves 8c1 are arranged in a spiral fashion.

The bearing sleeve 8 is obtained by compacting into a cylindrical configuration a mixed metal powder containing Cu (or Cu alloy) powder, SUS powder, and Sn powder as a low melting point metal powder, and sintering it at a predetermined sintering temperature. Further, in this embodiment, rotation sizing and groove sizing are effected on the inner peripheral surface 8a, whereby the hydrodynamic pressure grooves 8a1, 8c1, etc. are formed in the outer surface of the sintered body. Prior to the rotation sizing and groove sizing, dimensional sizing is effected, whereby is it possible to perform each sizing operation in the post-process with high precision. Further, by coating the surfaces of the particles of the Cu powder with Sn powder (i.e., by using an Sn-coated Cu powder), it is possible to simplify the powder mixing process. Further, at the time of sintering, Sn is uniformly dispersed among the Cu powder particles, whereby it is possible to further enhance the binder effect.

It is desirable for the size of the Cu powder used as the material of the bearing sleeve 8 to be equal to or smaller than that of the SUS powder. Further, in this embodiment, the mixing proportion of the Cu powder, the SUS powder, and the Sn powder is preferably as follows: Cu powder: not less than 40 wt % and not more than 94.5 wt %; SUS powder: not less than 5 wt % and not more than 50 wt %; and Sn powder: not less than 0.5 wt % and not more than 10 wt %. When the mixing amount of the SUS powder is less than 5 wt %, the wear resistance improving effect due to the SUS powder is insufficient. On the other hand, when it exceeds 50 wt %, the sizing after the sintering, in particular, the formation of the above-mentioned hydrodynamic pressure grooves 8a1, 8c1, etc. becomes difficult.

Further, for the purpose of improving the formability at the time of compacting, or the sliding property of the completed product, it is possible to further mix a slid lubricant, such as graphite, into the above-mentioned mixed metal powder. In this case, when the mixing amount of the graphite is too large, the graphite may hinder the sintering action between the metal powder particles, and there is a fear of the strength of the sintered body being reduced. Further, when the bearing sleeve 8 (the fluid lubrication bearing device 1) is used, the portion of the graphite which has not been connected with the other metal powder particles may be separated from the bearing sleeve 8 to be mixed into the lubricating oil as a contaminant. Taking these points into account, it is desirable for the upper limit value of the mixing amount of the graphite to be 2.5 wt %.

On the other hand, when the mixing amount of the graphite is too small, there is a fear of the adverse effect on the formability due to the mixing of the SUS powder not being covered. That is, due to the mixing of the SUS powder, which is poor in sintering property with respect to other metals, the molding (the sintered body) itself becomes rather fragile, so at the time of secondary formation, such as sizing, chipping of the sintered body is likely to occur due, for example, to the extraction force with which the molding is extracted from the mold at the time of releasing. In particular, at the time of groove sizing, the core rod for forming the hydrodynamic pressure grooves 8a1, 8a2 is pulled out through enlargement of the inner peripheral surface 8a due to the spring back of the sintered body, so more or less obstruction is unavoidable. However, when the sintered body is poor in sliding property, an enormous extraction force (resisting force) is exerted on the hydrodynamic pressure grooves 8a1 and 8a2 or on the peripheral regions thereof. Thus, when the sintered body is fragile, chipping easily occurs. Thus, there is a fear of the formation accuracy of the hydrodynamic pressure grooves 8a1 and 8a2 being rather insufficient and a sufficient hydrodynamic pressure action not being exerted.

From the above viewpoints it is desirable for the lower limit value of the mixing amount of graphite to be 0.5 wt %. This helps to improve the sliding property with respect to the mold at the time of molding and to reduce damage of the mold. Further, at the time of releasing in the groove sizing, the extraction of the core rod is smoothened, whereby the extraction force (resisting force) acting on the sintered body, in particular, the hydrodynamic pressure grooves 8a1 and 8a2 and the peripheral regions thereof is minimized, thereby making it possible to improve the formation accuracy of the hydrodynamic pressure grooves 8a1 and 8a2. In particular, when, as in this embodiment, the hydrodynamic pressure grooves 8a1 and 8a2 are provided in the bearing sleeve 8, graphite enters the gaps (voids) between the metal powder particles neck-connected with each other through sintering, whereby it is possible to reduce the relief of the hydrodynamic pressure generated in the hydrodynamic pressure grooves 8a1 and 8a2. Thus, it is possible to further enhance the bearing performance (bearing stiffness).

In this case, the mixing proportion of the whole is preferably as follows: Cu powder: not less than 40 wt % and not more than 94 wt %; SUS powder: not less than 5 wt % and not more than 50 wt %; Sn powder: not less than 0.5 wt % and not more than 10 wt %; and graphite: not less than 0.5 wt % and not more than 2.5 wt %.

The temperature at the time of sintering (sintering temperature) is preferably not lower than 750° C. and not higher than 1000° C., and more preferably, not lower than 800° C. and not higher than 950° C. This is due to the fact that when the sintering temperature is lower than 750° C., the sintering action between the powder particles is not sufficient, resulting in a reduction in the strength of the sintered body. On the other hand, when the sintering temperature exceeds 1000° C., there is, for the same reason as mentioned above, a fear in that the groove formability at the time of sizing is deteriorated.

By thus forming the sintered body, the circularity of the inner peripheral surface and the outer peripheral surface of the sintered body after sizing, the groove depth of the hydrodynamic pressure grooves 8a1 and 8c1, etc. are finished with high accuracy. Finally, this sintered body is impregnated with a lubricating oil (usually after being fixed to the housing 7), thereby completing the bearing sleeve 8 as a sintered oil-impregnated bearing. The density of the bearing sleeve 8 as the finished product is, for example, 7.0 to 7.4 μg/cm³, and the surface hole area ratio of the inner peripheral surface of the bearing sleeve 8 as the finished product is 2 to 10 [vol %]. In this way, by using a mixed metal powder containing Cu powder and SUS powder in a predetermined proportion, it is possible to obtain a bearing sleeve (sintered oil-impregnated bearing) 8 superior in the sliding property and hardness of the bearing surface, main body mechanical strength, and workability.

In this embodiment, as the SUS powder to be contained in the mixed metal powder, there is used, for example, one containing not less than 5 wt % and not more than 16 wt % of Cr. By using SUS powder in which Cr is alloyed within this range, it is possible to achieve a bearing sleeve 8 improved in wear resistance and having a high level of formability after sintering (sizing workability and formability of the hydrodynamic pressure grooves 8a1 and 8c1) and a high level of sintered body strength. Further, as in this embodiment, when forming a bearing sleeve 8 having hydrodynamic pressure grooves 8a1 and 8a2, among SUS powders containing Cr within the above range, SUS powder containing not less than 6 wt % and not more than 10 wt % of Cr (e.g., SUS powder containing 8 wt % of Cr) is particularly suitable. By using SUS powder in which Cr is alloyed within this range, the adjustment of the surface hole area ratio through rotation sizing is facilitated while imparting an appropriate hardness to the bearing surface of the bearing sleeve 8, and it is possible to further enhance the sizing workability (formability) of the hydrodynamic pressure grooves 8a1 and 8a2.

The seal member 9 is formed in an annular configuration, for example, of a resin material or a metal material, and is arranged in the inner periphery of the upper end portion of the cylindrical portion 7a of the housing 7. The inner peripheral surface 9a of the seal member 9 is opposed to a tapered surface 2a2 provided in the outer periphery of the shaft portion 2a through the intermediation of a predetermined seal space S. The tapered surface 2a2 of the shaft portion 2a is gradually diminished in diameter toward the upper side (the outer side with respect to the housing 7), and also functions as a capillary force seal and a centrifugal force seal during rotation of the shaft member 2.

The shaft member 2 and the bearing sleeve 8 are inserted into the inner periphery of the housing 7, and positioning of the bearing sleeve 8 in the axial direction is effected by the step portion 7d. Then, the bearing sleeve 8 is fixed to the inner peripheral surface 7c of the housing 7 by, for example, adhesion, press-fitting, welding, etc. Then, the lower end surface 9b of the seal member 9 is brought into contact with the upper end surface 8b of the bearing sleeve 8, and then the seal member 9 is fixed to the inner peripheral surface 7c of the housing 7. After this, the inner space of the housing 7 is filled with a lubricating oil, thereby completing the assembly of the fluid lubrication bearing device 1. At this time, the oil level of the lubricating oil filling the inner space of the housing 7 sealed by the seal member 9 (inclusive of the inner voids of the bearing sleeve 8) is maintained within the range of the seal space S.

During rotation of the shaft member 2, the regions of the inner peripheral surface 8a of the bearing sleeve 8 constituting the radial bearing surfaces (the upper and lower two regions where the hydrodynamic pressure grooves 8a1 and 8a2 are formed) are opposed to the outer peripheral surface 2a1 of the shaft portion 2a through the intermediation of the radial bearing gap. As the shaft member 2 rotates, the lubricating oil in the radial bearing gap is forced toward the axial centers m of the hydrodynamic pressure grooves 8a1 and 8a2, and undergoes an increase in pressure. By this hydrodynamic pressure action of the hydrodynamic pressure grooves, there are formed a first radial bearing portion R1 and a second radial bearing portion R2 supporting the shaft portion 2a in a non-contact fashion.

At the same time, in the thrust bearing gap between the upper end surface 2b1 of the flange portion 2b and the lower end surface 8c of the bearing sleeve 8 opposed thereto (the region where the hydrodynamic pressure grooves 8c1 are formed), and in the thrust bearing gap between the lower end surface 2b2 of the flange portion 2b and the upper end surface 7b1 of the bottom portion 7b (the region where hydrodynamic pressure grooves are formed), there are respectively formed lubricating oil films by the hydrodynamic pressure action of the hydrodynamic pressure grooves. By the pressure of those oil films, there are formed a first thrust bearing portion T1 and a second thrust bearing portion T2 supporting the flange portion 2b in both thrust directions rotatably in a non-contact fashion.

Even if, when the rotation of the shaft member 2 is started or stopped, contact sliding occurs between the shaft portion outer peripheral surface 2a1 of the shaft member 2 and the inner peripheral surface 8a of the bearing sleeve 8 opposed thereto (i.e., the radial bearing surface thereof), the hardness of the radial bearing surface constituting the sliding surface is enhanced by forming the bearing sleeve 8 of a mixed metal powder containing Cu powder and SUS powder. As a result, the difference in hardness between the two surfaces 2a1 and the 8a is diminished, so it is possible to prevent as far as possible one or both of the bearing sleeve 3 and the shaft portion 2a of the shaft member 2 in sliding contact with each other from being worn. In particular, as in this embodiment, in the state in which the disk hub 3 and the disks D are attached to the upper portion of the shaft member 2, a moment load is exerted on the shaft member 2, and the shaft member 2 and the bearing sleeve 8 are likely to be brought into sliding contact with each other in the upper portion of the bearing. However, by diminishing the difference in hardness between the two members 2a and 8 (the difference in hardness between the two sliding surfaces 2a1 and 8a) as stated above, it is possible to suppress sliding wear between them as far as possible.

While in the first embodiment described above the housing 7 consists of the cylindrical portion 7a and the bottom portion 7b formed integrally of resin, it is also possible, for example, although not shown, to form the cylindrical portion 7a and the bottom portion 7b separately of resin. In this case, it is also possible, for example, to form the seal member 9 and the cylindrical portion 7a integrally of resin, thereby making it possible to effect positioning of the bearing sleeve S in the axial direction by bringing the upper end surface 8b of the bearing sleeve 8 into contact with the lower end surface of the seal portion formed integrally with the cylindrical portion 7a.

Further, while in the first embodiment described above the thrust bearing portion is provided on the bottom portion 7b side of the housing 7, it is also possible, for example, to provide the thrust bearing portion on the side opposite to the bottom portion 7b (the opening side of the housing 7). In this case, although not shown, for example, the flange portion 2b formed of metal (e.g., stainless steel) is formed above the lower end of the shaft portion 2a, and the lower end surface 2b2 of the flange portion 2b is opposed to the upper end surface 8b of the bearing sleeve 8. Further, hydrodynamic pressure grooves similar to the hydrodynamic pressure grooves 8c1 (but oppositely directed) are formed all over or in a partial annular region of the upper end surface 8b. As a result, a thrust bearing gap is formed between the two surfaces 8b and 2b2.

When the rotation of the shaft member 2 is started or stopped, contact sliding occurs between the lower end surface 2b2 of the flange portion 2b and the upper end surface 8b of the bearing sleeve 8 opposed thereto (the region constituting the thrust bearing surface thereof). In this case also, by forming the bearing sleeve 8 of a mixed metal powder containing Cu powder and SUS powder, the hardness of the upper end surface 8b including the thrust bearing surface is enhanced. As a result, the difference in hardness between the two surfaces 2b2 and 8b is reduced, and it is possible to prevent as far as possible one or both of the bearing sleeve 8 and the flange portion 2b of the shaft member 2 from being worn.

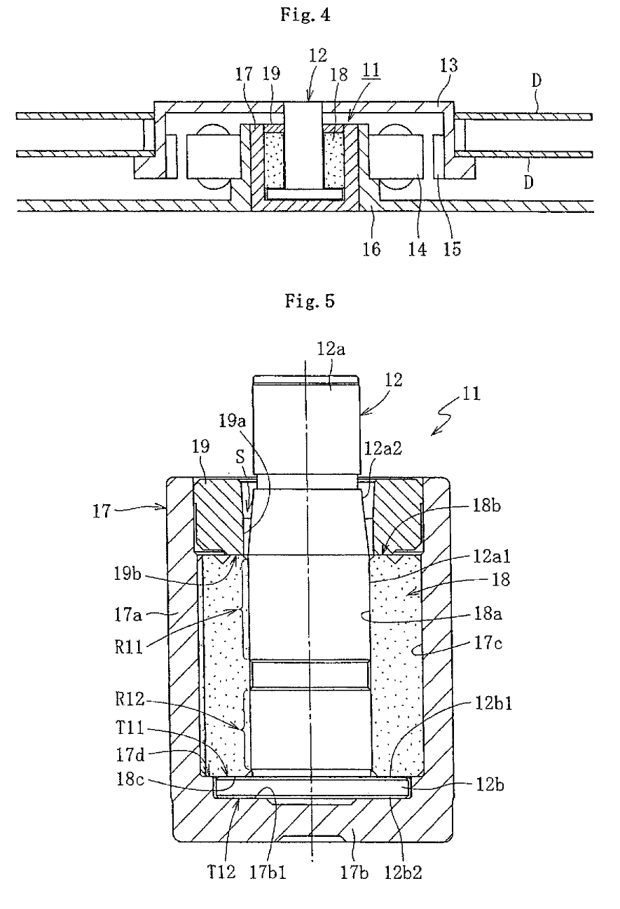

In the following, a second embodiment of the present invention will be described with reference to FIGS. 4 through 7.

FIG. 4 is a conceptual drawing showing a construction example of an information apparatus spindle motor in which a fluid lubrication bearing device 11 (hydrodynamic pressure bearing device) is incorporated. This spindle motor is used in a disk drive device, such as an HDD, and is equipped with the fluid lubrication bearing device 11 supporting a shaft member 12 rotatably in a non-contact fashion, a disk hub 13 attached to the shaft member 12, and a stator coil 14 and a rotor magnet 15 that are opposed each other through the intermediation of a radial gap. The stator coil 14 is attached to the outer periphery of a bracket 16, and the rotor magnet 15 is attached to the inner periphery of the disk hub 13. The disk hub 13 retains in its outer periphery one or a plurality of (two in FIG. 4) disks D. In the spindle motor, constructed as described above, when the stator coil 14 is energized, the rotor magnet 15 is caused to rotate by an electromagnetic force generated between the stator coil 14 and the rotor magnet 15, and with this rotation, the disk hub 13 and the disks D retained by the disk hub 13 rotate integrally with the shaft member 12.

FIG. 5 shows the fluid lubrication bearing device 11. The fluid lubrication bearing device 11 is mainly composed of the shaft member 12, a housing 17, a bearing sleeve 18 fixed to the housing 17, and a seal member 19. For the sake of convenience in illustration, the bottom portion 17b side of the housing 17 will be referred to as the lower side and the side thereof opposite to the bottom portion 17b will be referred to as the upper side.

The shaft member 12 is formed of a metal material, such as stainless steel, and is equipped with a shaft portion 12a and a flange portion 12b provided integrally or separately at the lower end of the shaft portion 12a. The shaft member 12 may also be of a hybrid structure consisting of a metal material and a resin material. In this case, the sheath portion including at least the outer peripheral surface 12a1 of the shaft portion 12a is formed of the metal, and the remaining portions (e.g., the core portion of the shaft portion 12a and the flange portion 12b) are formed of resin. To secure the requisite strength of the flange portion 12b, it is also possible to form the flange portion 12b as a hybrid structure consisting of resin and metal, forming the core portion of the flange portion 12b of metal along with the sheath portion of the shaft portion 12a.

The housing 17 is formed by injection molding of a resin composition whose base resin is LCP, PPS, PEEK or the like, and as shown, for example, in FIG. 5, is composed of a cylindrical portion 17a and a bottom portion 17b formed integrally at the lower end of the cylindrical portion 17a. According to the purpose, it is possible to use, as the resin composition forming the housing 17, the ones obtained by mixing the above base resin, in an appropriate amount, with, for example, a fibrous filler, such as glass fiber, a whisker-like filler, such as potassium titanate, a scaly filler, such as mica, and a fibrous or a powdered conductive filler, such as carbon fiber, carbon black, graphite, carbon nanomaterial, or various kinds of metal powder.

For example, although not shown, there is formed, all over or in a partially annular region of the upper end surface 17b1 of the bottom portion 17b, a region where a plurality of hydrodynamic pressure grooves are arranged in a spiral fashion as a thrust hydrodynamic pressure generating portion. This hydrodynamic pressure generating region is opposed to the lower end surface 12b2 of the flange portion 12b, and during rotation of the shaft member 12, forms a thrust bearing gap of a second thrust bearing portion T12 (see FIG. 5) between itself and the lower end surface 12b2. Such hydrodynamic pressure grooves can be formed simultaneously with the housing 17 by machining, at a predetermined position of the mold for molding the housing 17 (the position where the upper end surface 17b1 is to be formed), groove forms for forming the hydrodynamic pressure grooves. Further, at a position upwardly spaced apart in the axial direction from the upper end surface 17b1 by a predetermined dimension, there is integrally formed a step portion 17d to be engaged with the lower end surface 18c of the bearing sleeve 18 to effect positioning in the axial direction.

The bearing sleeve 18 is formed in a cylindrical configuration of a porous material consisting of a sintered material whose main components are Cu and low linear expansion metal, and is fixed to the inner peripheral surface 17c of the housing 17.

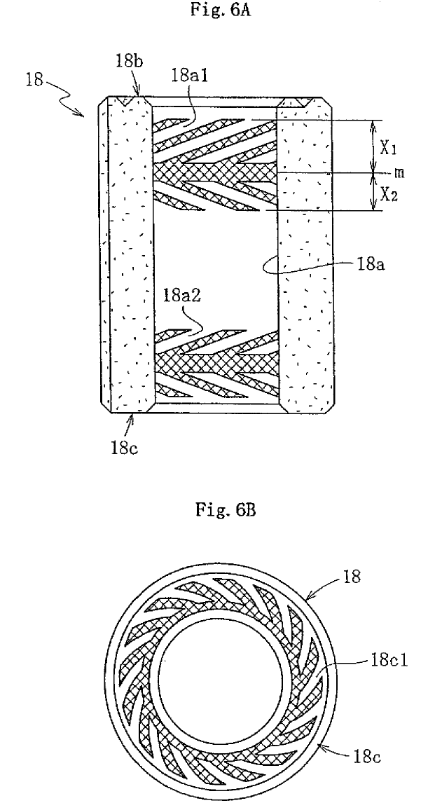

All over or in a partial cylindrical region of the inner peripheral surface 18a of the bearing sleeve 18, there are formed hydrodynamic pressure grooves as the radial hydrodynamic pressure generating portion. As shown, for example, in FIG. 6A, in this embodiment, there are formed two regions axially spaced apart from each other in which a plurality of hydrodynamic pressure grooves 18a1 and 18a2 are arranged in a herringbone-like fashion. In the upper region, where the hydrodynamic pressure grooves 18a1 are formed, the hydrodynamic pressure grooves 18a1 are formed in an axial asymmetry with respect to the axial center m (the axial center of the region between the upper and lower oblique grooves), with the axial dimension X1 of the region on the upper side of the axial center m being larger than the axial dimension X2 of the region on the lower side of the axial center m.

As shown, for example, in FIG. 6B, all over or in a partial annular region of the lower end surface 1c of the bearing sleeve 18, there is formed a region where a plurality of hydrodynamic pressure grooves 18c1 are arranged in a spiral fashion.

The bearing sleeve 18 is obtained by compacting into a cylinder a mixed metal powder containing, for example, pure cu powder, a Super-Invar type alloy powder (hereinafter simply referred to as the S.Invar powder) as a low linear expansion metal powder, and SUS powder (and further, in some cases, Sn powder and P powder as low melting point metal powder, or an alloy powder thereof), and sintering this at a predetermined sintering temperature. In this embodiment, dimensional sizing, rotational sizing, and groove sizing are performed sequentially, thereby effecting sizing to a predetermined dimension on the sintered body, and forming hydrodynamic pressure grooves 18a1, 18c1, etc. in the surface of the sintered body. To improve the formability at the time of compacting or the sliding property of the finished product, it is also possible to further mix a solid lubricant, such as graphite, into the above mixed metal powder. In this case, taking into account the reduction in the strength of the sintered body due to the mixing of the graphite, it is desirable for the upper limit value of the mixing amount of graphite to be 2.5 wt %. Further, from the viewpoint of improving the sliding property with respect to the mold at the time of molding, it is desirable for the lower limit value of the mixing amount of graphite to be 0.5 wt %.

It is desirable for the grain size of the pure Cu powder used as the material of the bearing sleeve 18 to be equal to or smaller than that of the S.Invar powder and the SUS powder. Further, the mixing proportion of the pure Cu powder, the S.Invar powder, and the SUS powder in this embodiment is preferably as follows: the pure Cu powder: not less than 30 wt % and not more than 80 wt %; the S.Invar powder: not less than 10 wt % and not more than 65 wt %; and the SUS powder: not less than 5 wt % and not more than 60 wt %. When the mixing amount of SUS powder is less than 5 wt %, there is a fear in that the reinforcing effect and the wear resistance improving effect due to the SUS powder become insufficient. Pure Cu powder is superior in malleability, and is a material suitable for improving the formability of the sintered body, in particular, the sizing workability after sintering. When the mixing ratio of the pure Cu powder is reduced, there is a fear in that the sizing after sintering, in particular, the groove sizing of the hydrodynamic pressure grooves 18a1, 18c1, etc. become difficult. From this viewpoint, it is desirable for the mixing ratio of the pure Cu powder to be 30 wt % or more.

The temperature at the time of sintering (sintering temperature) is preferably not lower than 750° C. and not higher than 1000° C., and more preferably, not lower than 800° C. and not higher than 950° C. This is due to the fact that when the sintering temperature is lower than 750° C., the sintering action between the powder particles is not sufficient, resulting in a reduction in the strength of the sintered body. On the other hand, when the sintering temperature exceeds 1000° C., there is, for the same reason as mentioned above, a fear in that the groove formability at the time of sizing is deteriorated.

When mixing Sn powder with the mixed metal powder, its mixing ratio with respect to the total mixed metal powder is preferably not less than 0.2 wt % and not more than 10 wt %. Within the range of this ratio, the Sn powder is melted (liquefied) at the above-mentioned sintering temperature, and functions as a binder between the other powders (pure Cu powder, S.Invar powder, etc.). Further, by alloying it with pure Cu powder within the above mixing ratio range, it is possible to maintain to an appropriate degree the inherent superior workability (in particular, plastic deformability) of the pure Cu while improving the wear resistance of the sintered body.

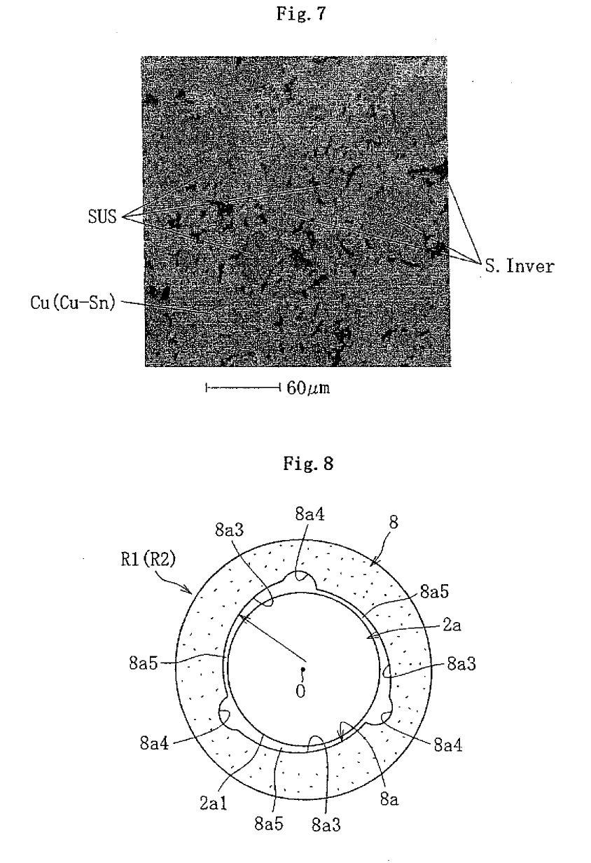

In this way, by using a mixed metal powder containing pure Cu powder, low linear expansion metal powder (S.Invar powder), SUS powder, and Sn powder in a predetermined proportion, it is possible to obtain a bearing sleeve 18 having, in addition to a low linear expansion coefficient, a high mechanical strength, and superior in the sliding property of the bearing surface (wear resistance, conformability) and dimensional accuracy. The density of the bearing sleeve 18 as the finished product is, for example, 7.0 to 7.4 [g/cm³], and the surface hole area ratio of the bearing sleeve 18 as the finished product is 2 to 10 [vol %]. FIG. 7 is a microphotograph showing, by way of example, the interior of a bearing sleeve 18 formed of the mixed metal powder containing pure Cu powder, S.Invar powder, SUS powder, and Sn powder.

The seal member 19 is formed in an annular configuration, for example, of a resin material or a metal material, and is arranged in the inner periphery of the upper end portion of the cylindrical portion 17a of the housing 17. The inner peripheral surface 19a of the seal member 19 is opposed to a tapered surface 12a2 provided in the outer periphery of the shaft portion 12a through the intermediation of a predetermined seal space S. The tapered surface 12a2 of the shaft portion 12a is gradually diminished in diameter toward the upper side (the outer side with respect to the housing 17), and also functions as a capillary force seal and a centrifugal force seal during rotation of the shaft member 12.

The shaft member 12 and the bearing sleeve 18 are inserted into the inner periphery of the housing 17, and positioning of the bearing sleeve 18 in the axial direction is effected by the step portion 17d. Then, the bearing sleeve 18 is fixed to the inner peripheral surface 17c of the housing 17 by, for example, adhesion, press-fitting, welding, etc. Then, the lower end surface 19b of the seal member 19 is brought into contact with the upper end surface 18b of the bearing sleeve 18, and then the seal member 19 is fixed to the inner peripheral surface 17c of the housing 17. After this, the inner space of the housing 17 is filled with a lubricating oil, thereby completing the assembly of the fluid lubrication bearing device 11. At this time, the oil level of the lubricating oil filling the inner space of the housing 17 sealed by the seal member 19 (inclusive of the inner voids of the bearing sleeve 18) is maintained within the range of the seal space S.

During rotation of the shaft member 12, the regions of the inner peripheral surface 18a of the bearing sleeve 18 constituting the radial bearing surfaces (the upper and lower two regions where the hydrodynamic pressure grooves 18a1 and 18a2 are formed) are opposed to the outer peripheral surface 12a1 of the shaft portion 12a through the intermediation of the radial bearing gap. As the shaft member 12 rotates, the lubricating oil in the radial bearing gap is forced toward the axial centers m of the hydrodynamic pressure grooves 18a1 and 18a2, and undergoes an increase in pressure. By this hydrodynamic pressure action of the hydrodynamic pressure grooves 18a1 and 18a2, there are formed a first radial bearing portion R11 and a second radial bearing portion R12 supporting the shaft portion 12a in a non-contact fashion (see FIG. 5).

At the same time, in the thrust bearing gap between the upper end surface 12b1 of the flange portion 12b and the lower end surface 18c of the bearing sleeve 18 opposed thereto (the region where the hydrodynamic pressure grooves 18c1 are formed), and in the thrust bearing gap between the lower end surface 12b2 of the flange portion 12 and the region which is to be a thrust bearing surface of the upper end surface 17b1 of the bottom portion 17b (the region where hydrodynamic pressure grooves are formed), there are respectively formed lubricating oil films by the hydrodynamic pressure action of the hydrodynamic pressure grooves. By the pressure of those oil films, there are formed a first thrust bearing portion T11 and a second thrust bearing portion T12 supporting the flange portion 12b in both thrust directions rotatably in a non-contact fashion.

When used in a high temperature atmosphere, both the shaft member 12 and the bearing sleeve 18 expand, and the outer peripheral surface 12a1 of the shaft portion 12a and the inner peripheral surface 18a of the bearing sleeve 18 including the radial bearing surface are displaced outwardly. Here, the bearing sleeve 18 is formed of a mixed metal powder containing S.Invar powder, so the displacement amount of the inner peripheral surface 18a of the bearing sleeve 18 due to temperature rise is substantially equal to or smaller than the displacement amount of the outer peripheral surface 12a1 of the shaft portion 12a. As a result, it is possible to maintain the radial bearing gap between the radial bearing surface of the inner peripheral surface 18a and the outer peripheral surface 12a1 opposed thereto at least at the same level as compared to the gap prior to the temperature rise. Thus, even in a case in which the viscosity of the lubricating oil is reduced due to temperature rise, it is possible to suppress the reduction in bearing stiffness as far as possible. Further, at the time of a reduction in temperature, it is possible to maintain the radial bearing gap between the inner peripheral surface 18a and the outer peripheral surface 12a1 at least at the same level as compared with that prior to the temperature reduction. Thus, even in a case in which the viscosity of the lubricating oil increases due to a reduction in temperature, it is possible to reduce as far as possible the loss torque during rotation (in particular, at the start of rotation).

Further, by mixing, in addition to S.Invar powder, SUS powder into the mixed metal powder, the hardness of the regions of the inner peripheral surface 18a constituting the radial bearing surfaces (the regions where the hydrodynamic pressure grooves 18a1 and 18a2 are formed) is enhanced. As a result, the difference in hardness between the opposing surfaces 12a1 and 18a is reduced, and even when the bearing sleeve 18 and the shaft portion 12a make contact sliding with respect to each other (e.g., at the start of rotation), it is possible to prevent, as far as possible, one or both of them from being worn.

In the second embodiment described above, the housing 17 consists of the cylindrical portion 17a and the bottom portion 17b formed integrally of resin. Although not shown, apart from this, it is also possible, for example, to form the cylindrical portion 17a and the bottom portion 17b separately of resin. In this case, it is also possible, for example, to form the seal member 19 of resin integrally with the cylindrical portion 17a. In this construction, it is possible to perform the axial positioning of the bearing sleeve 18 by bringing the upper end surface 18b of the bearing sleeve 18 into contact with the lower end surface of the seal portion formed integrally with the cylindrical portion 17a. Further, the housing 17 is not restricted to an injection-molded product of a resin material. For example, it may also be a turning-operation product or a press-working product of a metal material.

While in the above-described embodiments (the first embodiment and the second embodiment) there are formed the radial bearing portions R1, R2, R11, and R12, and the thrust bearing portions T1, T2, T11, and T12 in which a hydrodynamic pressure action of a lubricating fluid is generated by hydrodynamic pressure grooves of a herringbone-like configuration and a spiral configuration, the present invention is not restricted to such a construction.

It is also possible, for example, to adopt so-called step bearings or multi-lobed bearings as the radial bearing portions R11 and R12. In the following, there is shown a case in which a step bearing or a multi-lobed bearing is adopted in the fluid lubrication bearing device 1 of the first embodiment. Of course, it is also possible to adopt a similar construction in the fluid lubrication bearing device 11 of the second embodiment.

FIG. 8 shows an example of a case in which one or both of the radial bearing portions R1 and R2 are formed by multi-lobed bearings. In the figure, the region of the inner peripheral surface 8a of the bearing sleeve 8 constituting the radial bearing surface is formed by a plurality of (three, in this figure) arcuate surfaces 8a3. The arcuate surfaces 8a3 are eccentric arcuate surfaces whose centers are points offset from the rotation center O by the same distance and which are arranged at equal circumferential intervals. Between the eccentric arcuate surfaces 8a3, there are formed axial separation grooves 8a4.

By inserting the shaft portion 2a of the shaft member 2 into the inner periphery of the bearing sleeve 8, there are respectively formed the radial bearing gaps of the first and second radial bearing portions R1 and R2 between the eccentric arcuate surfaces 8a3 and the separation grooves 8a4 of the bearing sleeve 8 and the perfectly cylindrical outer peripheral surface 2a1 of the shaft portion 2a. Of the radial bearing gaps, the regions formed by the eccentric arcuate surfaces 8a3 and the perfectly cylindrical outer peripheral surface 2a1 are wedge-like gaps 8a5 whose gap width is gradually diminished in one circumferential direction. The diminishing direction of the wedge-like gaps 8a5 coincides with the rotating direction of the shaft member 2.

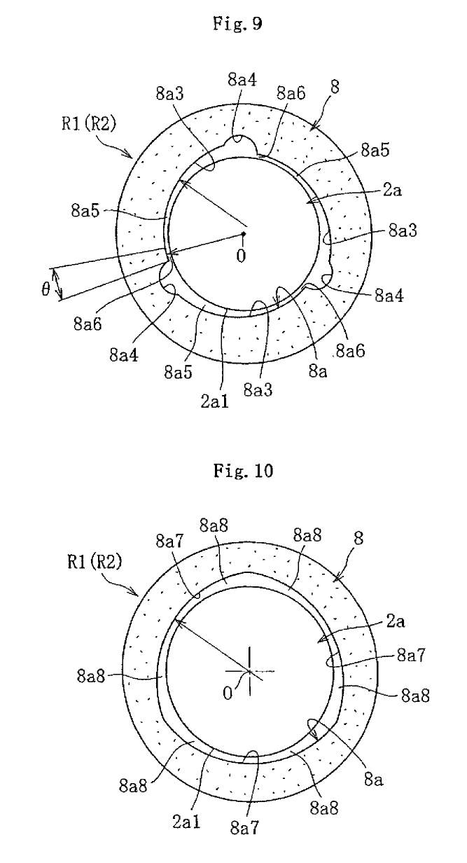

FIG. 9 shows another example of a multi-lobed bearing forming the first and second radial bearing portions R1 and R2. In this embodiment, in the construction shown in FIG. 8, predetermined regions θ on the minimum gap side of the eccentric arcuate surfaces 8a3 are formed by concentric arcs whose center is the rotation center O. Thus, the radial bearing gaps (minimum bearing gaps) 8a6 of the predetermined regions θ are fixed. A multi-lobed bearing of this construction is sometimes referred to as a taper/flat bearing.

In FIG. 10, the region of the inner peripheral surface 8a of the bearing sleeve 8 constituting the radial bearing surface is formed by three arcuate surfaces 8a7, and the centers of the three arcuate surfaces 8a7 are offset from the rotation center O by the same distance. In the regions defined by the three eccentric arcuate surfaces 8a7, the radial bearing gaps 8a8 are gradually diminished in both circumferential directions.

The above-mentioned multi-lobed bearings of the first and second radial bearing portions R1 and R2 are all so-called three-arc bearings, this should not be construed restrictively. It is also possible to adopt a so-called four-arc bearing, five-arc bearing, or a multi-lobed bearing formed by six or more arcs. Further, apart from the construction in which the two radial bearing portions are axially spaced apart from each other as in the case of the radial bearing portions R1 and R2, it is also possible to adopt a construction in which a single radial bearing portion is formed to extend over the vertical region of the inner peripheral surface 8a of the bearing sleeve 8.

Further, although not shown, it is also possible, for example, for one or both of the thrust bearing portions T1 and T2 to have in the regions constituting the thrust bearing surfaces so-called step bearings, so-called corrugated bearings (whose step form is corrugated), etc. in which a plurality of hydrodynamic pressure grooves in the form of radial grooves are provided at predetermined circumferential intervals. Of course, in this case also, it is possible to adopt the above construction of the thrust bearing portions T1 and T2 in the fluid lubrication bearing device 11 of the second embodiment.

Further, while in the first and second embodiments the radial bearing portions R1 and R2 and the thrust bearing portions T1 and T2 are formed by hydrodynamic pressure bearings, it is also possible to form them by other types of bearing. For example, in the case of the fluid lubrication bearing device 1 of the first embodiment, it is possible to form the inner peripheral surface 8a of the bearing sleeve 8 constituting the radial bearing surface as a perfectly cylindrical inner peripheral surface equipped with no hydrodynamic pressure grooves 8a1 or arcuate surfaces 8a3 as the hydrodynamic pressure generating portions, and to form a so-called cylindrical bearing by this inner peripheral surface and the perfectly cylindrical outer peripheral surface 2a1 of the shaft portion 2a opposed thereto.

When thus adopting a cylindrical bearing in the fluid lubrication bearing device 1 of the first embodiment, the preferable mixing ratio of the Cu powder is not less than 30 wt % and not more than 80 wt %. Here, the reason for setting the lower limit value 30 wt % is that, as compared with the case of the bearing sleeve 8, in which the hydrodynamic pressure grooves 8a1 as the hydrodynamic pressure generating portions are formed in the inner peripheral surface, the perfectly cylindrical inner peripheral surface exhibits a larger sliding area during contact sliding, and involves an increase in loss torque at the start (stopping) of rotation.

The above-described cylindrical bearing is applicable not only to the fluid lubrication bearing device 1, but also, for example, to a small motor or a bearing component for office equipment.

Further, without being restricted to the cylindrical bearing as described above, the fluid lubrication bearing device 1, 11 of the present invention can be used suitably as the bearing of a spindle motor for an information apparatus, for example, a magnetic disk device, such as an HDD, an optical disk device, such as a CD-ROM, CD-R/RW, or DVD-ROM/RAM, a magneto-optical disk device, such as an MD or MO, the bearing of a polygon scanner motor for a laser beam printer (LBP), and the bearing of other types of small motors.

Further, while in the first and second embodiments a lubricating oil is used as the fluid filling the interior of the fluid lubrication bearing device 1, 11 and forming lubricant films in the radial bearing gap and the thrust bearing gap, it is also possible to use some other fluid capable of forming a lubricant film in each bearing gap, for example, a gas, such as air, a lubricant with fluidity, such as a magnetic fluid, or a lubricating grease.

### Example 1

To prove the effect of the present invention, a wear test was conducted on sintered metal material (Example 1) formed of a mixed metal powder containing Cu powder and SUS powder, and a sintered metal material (Comparative Example 1) formed of a metal powder of a conventional composition (a mixed metal powder consisting of Cu powder and Fe powder) for evaluation and comparison in terms of wear resistance.

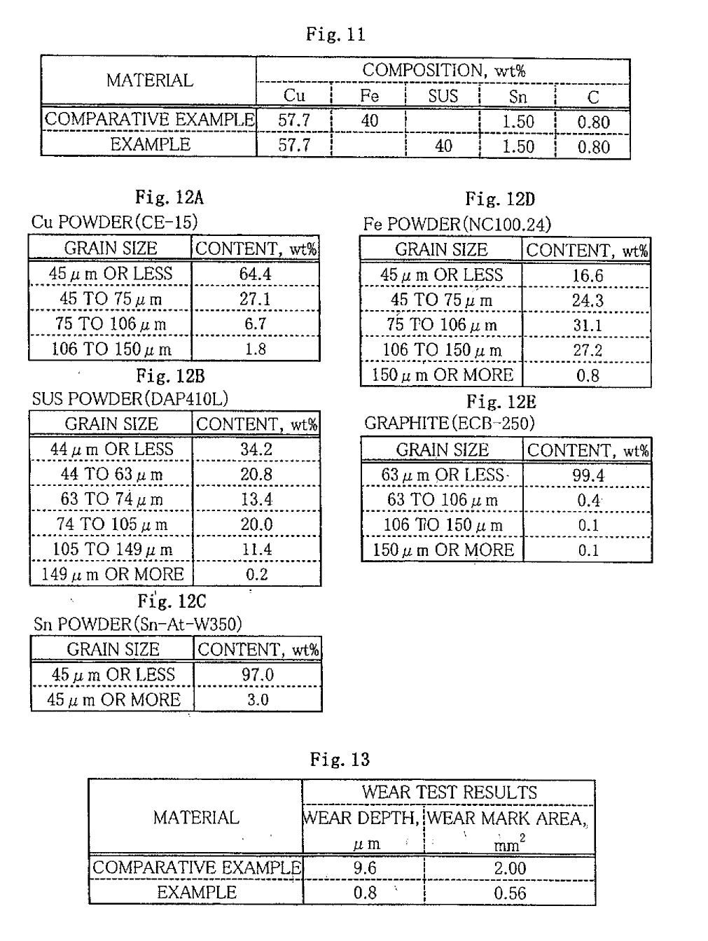

As the pure Cu powder, CE-15 manufactured by FUKUDA METAL FOIL & POWDER Co., Ltd. was used. As the SUS powder, DAP410L manufactured by Daido Steel Co., Ltd. was used. As the Fe powder, NC100.24 manufactured by HOGANAS JAPAN Co., Ltd. was used. Further, as the Sn powder as the low melting point metal, Sn-At-W350 manufactured by FUKUDA METAL FOIL & POWDER Co., Ltd. was used, and as the graphite as the solid lubricant, ECB-250 manufactured by Nippon Graphite Industry Co., Ltd. was used. The specimen (sintered metal material) sintering temperature was 870° C. for both Comparative Example and Example. The compositions of the mixed metal powders forming the Comparative Example and the Example are as shown in FIG. 11. The respective grain size distributions of the powders are as shown in FIGS. 12A through 12E.

The wear test was conducted under the following conditions for both the Comparative Example and the Example:

Specimen size: outer diameter 7.5 mm axial width 10 mm

Associated specimen:
material: SUS420J2
size: outer diameter 40 mm axial width 4 mm

Peripheral speed: 50 m/min.

Contact pressure: 1.3 MPa

Lubricating oil: ester oil (12 mm²/s)

Test time: 3 hrs.

FIG. 13 shows wear test results. As shown in the figure, marked wear was to be observed in a sintered metal material containing no SUS powder (Comparative Example 1). In contrast, in a sintered metal material (Example 1) formed of a metal powder containing SUS powder, the wear amount (wear depth and wear mark area) was very small as compared with a product of a conventional composition (Comparative Example 1). From this, the substantial wear amount reducing effect of the present invention was confirmed.

### Example 2

To prove the effect of the present invention, a linear expansion coefficient measurement test was conducted on specimens (Examples 2 through 5) formed of a mixed metal powder containing Cu powder and low expansion metal powder, and a specimen (Comparative Example 2) formed of a metal powder of a conventional composition (a mixed metal powder consisting of Cu powder and Fe powder) for evaluation and comparison of their coefficients of linear expansion. Further, wear test was conducted on, of the specimens (Examples 2 through 5), the ones containing SUS powder in addition to Cu powder and low expansion metal powder (Examples 3 through 5) and a conventional product (Comparative Example 2) for evaluation and comparison in terms of wear resistance.

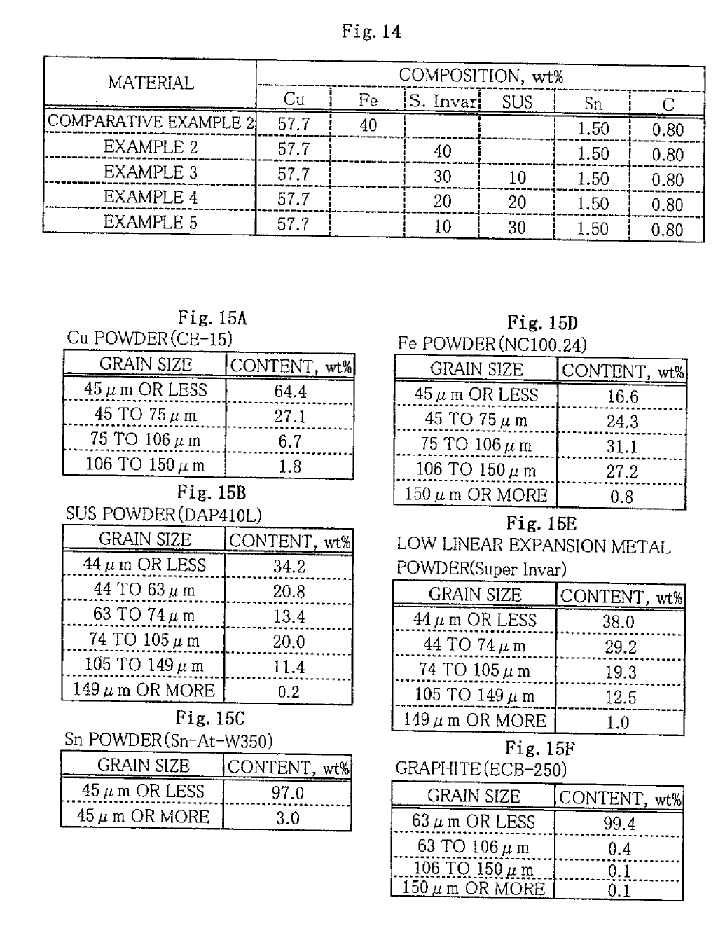

As the pure Cu powder, CE-15 manufactured by FUKUDA METAL FOIL & POWDER Co., Ltd. was used. As the S.Invar powder as the low linear expansion metal powder, SUPER INVAR manufactured by EPSON ATMIX CORPORATION was used. As the SUS powder, DAP410L (SUS410L) manufactured by Daido Steel Co., Ltd. was used. As the Fe powder, NC100.24 manufactured by Calderys Japan Co., Ltd. was used. Further, as the Sn powder as the low melting point metal, Sn-At-W350 manufactured by FUKUDA METAL FOIL & POWDER Co., Ltd. was used, and as the graphite as the solid lubricant, ECB-250 manufactured by Nippon Graphite Industry Co., Ltd. was used. The specimen (sintered metal material) sintering temperature was 870° C. for all of Comparative Example 2 and Examples 2 through 5. The compositions of the mixed metal powder s forming the Comparative Example and the Examples are as shown in FIG. 14. The respective grain size distributions of the powders are as shown in FIGS. 15A through 15F.

The linear expansion coefficient measurement test was conducted under the following conditions for both the Comparative Examples and the Examples:

Specimen: outer diameter 7.5 mm×axial width 10 mm

Measurement temperature: −40° C. to 120° C.

Temperature rising rate: 5° C./min.

Load: 10 gf

Nitrogen gas flow rate: 200 ml/min.

The wear test was conducted under the following conditions for both the Comparative Examples and the Examples:

Specimen: outer diameter 7.5 mm×axial width 10 mm

Associated specimen:
material: SUS420J2
size: outer diameter 40 mm axial width 4 mm

Peripheral speed: 50 m/min.

Contact pressure: 1.3 MPa

Lubricating oil: ester oil (12 mm²/s)

Test time: 3 hrs.

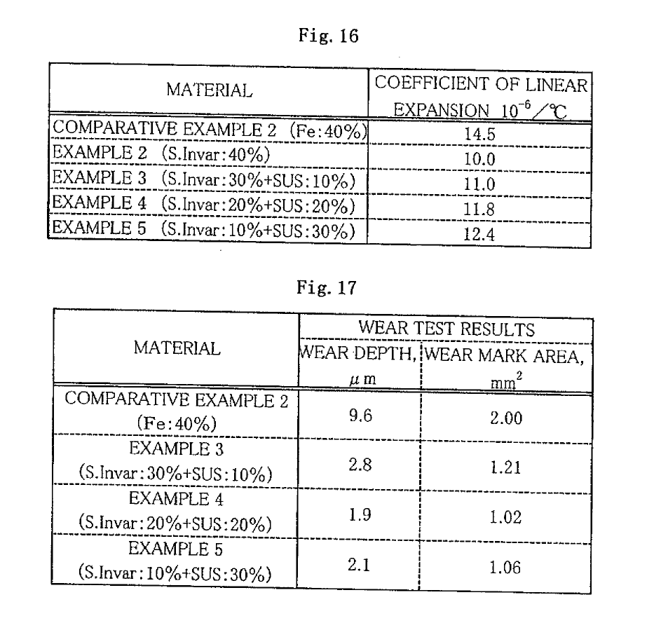

FIG. 16 shows the results of the linear expansion coefficient measurement test. As shown in the figure, the specimen (Comparative Example 2) containing no S.Invar powder exhibited a large coefficient of linear expansion. In contrast, in the specimens containing S.Invar powder (Examples 2 through 5), the value of the coefficient of linear expansion was small.

FIG. 17 shows wear test results. As shown in the figure, marked wear was to be observed in the specimen containing no SUS powder (Comparative Example 2). In contrast, in the specimen (Examples 3 to 5) formed of a metal powder containing SUS powder, the wear amount (wear depth and wear mark area) was very small as compared with the specimen of a conventional composition (Comparative Example 2).

1. A sintered metal material obtained by compacting a mixed metal powder containing Cu powder and SUS powder and then performing sintering on a compact of the mixed metal powder.

2. A sintered metal material according to claim 1, wherein the mixed metal powder contains equal to or more than 5 wt % and equal to or less than 95 wt % of the Cu powder and equal to or more than 5 wt % and equal to or less than 95 wt % of the SUS powder.

3. A sintered metal material according to claim 1, wherein the mixed metal powder is further mixed with a low melting point metal powder.

4. A sintered metal material according to claim 3, wherein the mixed metal powder contains equal to or more than 5 wt % and equal to or less than 94.8 wt % of the Cu powder, equal to or more than 5 wt % and equal to or less than 94.8 wt % of the SUS powder, and equal to or more than 0.2 wt % and equal to or less tan 10 wt % of the low melting point metal powder.

5. A sintered metal material according to claim 1, wherein the mixed metal powder is further mixed with a solid lubricant.

6. A sintered metal material according to claim 5, wherein the solid lubricant is graphite.

7. A sintered metal material according to claim 6, wherein an upper limit value of the graphite mixing amount is 2.5 wt %.

8. A sintered metal material according to claim 6 or 7, wherein a lower limit value of the graphite mixing amount is 0.5 wt %.

9. A sintered metal material according to claim 1, wherein the SUS powder contains equal to or more than 5 wt % and equal to or less than 16 wt % of Cr.

10. A sintered oil-impregnated bearing which is formed of a sintered metal material according to claim 1 and which has, in an inner periphery of the sintered oil-impregnated bearing, a bearing surface for supporting a sliding surface of a shaft to be supported through an intermediation of a fluid lubricant film.

11. A sintered oil-impregnated bearing according to claim 10, wherein the bearing surface includes a hydrodynamic pressure generating portion being formed in the bearing surface.

12. A fluid lubrication bearing device comprising a sintered oil-impregnated bearing according to claim 10.

13. A motor comprising a fluid lubrication bearing device according to claim 12.

14. A fluid lubrication bearing device comprising a shaft member and a bearing sleeve for rotatably supporting the shaft member,
wherein the bearing sleeve is obtained by compacting a mixed metal powder containing Cu powder and a metal powder exhibiting a coefficient of linear expansion of 8.0×10⁻⁶/° C., and then performing sintering on a compact of the mixed metal powder.

15. A fluid lubrication bearing device according to claim 14, wherein the mixed metal powder contains equal to or more than 30 wt % and equal to or less than 90 wt % of the Cu powder and equal to or more than 10 wt % and equal to or less than 70 wt % of the low linear expansion metal powder.

16. A fluid lubrication bearing device according to claim 14, wherein the mixed metal powder is further mixed with SUS powder.

17. A fluid lubrication bearing device according to claim 16, wherein the mixed metal powder contains equal to or more than 30 wt % and equal to or less than 80 wt % of the Cu powder, equal to or more than 10 wt % and equal to or less than 65 wt % of the low linear expansion metal powder, and equal to or more than 5 wt % and equal to or less than 60 wt % of the SUS powder.

18. A fluid lubrication bearing device according to claim 14, wherein the low linear expansion metal powder is an Fe—Ni alloy powder that contains equal to or more than 25 wt % and equal to or less than 50 wt % of Ni.

19. A fluid lubrication bearing device according to claim 18, wherein the Fe—Ni alloy powder is an Invar type alloy powder or a Super-Invar type alloy powder.

20. A fluid lubrication bearing device according to claim 14, wherein the bearing sleeve includes a hydrodynamic pressure generating portion being provided in an inner peripheral surface of the bearing sleeve.

21. A motor comprising a fluid lubrication bearing device according to claim 14.
